(19) United States
(12) Patent Application Publication
(10) Pub. No.: US 2004/0056535 A1
(43) Pub. Date: Mar. 25, 2004

(54) Power module

(75) Inventors: Saied Hussaini, Miami, FL (US); Marc Iacovelli, Miami, FL (US)

Correspondence Address: Liniak, Berenato & White, Ste. 240, 6550 Rock Spring Drive, Bethesda, MD, 20817, US

(73) Assignee: INTEC, INC.

(21) Appl. No.: 10/356,590

(22) Filed: Feb. 3, 2003

Related U.S. Application Data
(60) Provisional application No. 60/412,812, filed on Sep. 24, 2002.

(51) Int. Cl. H01H 1/00

(52) U.S. Cl. 307/112

(57) ABSTRACT

A power cord having an integral and unitarily formed surge protector and reset circuitry for delivering a power flow to a stand-alone computer gaming unit. The power cord with integrated surge protector allows for the gaming unit to be plugged into any power source without the necessity of a separate surge protector. A power switch is incorporated to allow a user or operator to turn the stand-alone computer gaming unit on or off without having to access the rear of the unit. An audio output indicator is located on a grill portion to illustrate the audio level through a series of LED lights.

This application claims the benefit of provisional application 60/412,812 filed on Sep. 24, 2002 and is hereby incorporated by reference.

### BACKGROUND OF THE INVENTION

1. Field of the Invention

The present invention relates to video game adapter pack with a surge protector and independent on/off switch. More specifically, the pack is affixed to a gaming device and has a power module that plugs into the gaming device to facilitate relocation of an on/off switch.

2. Description of the Related Art

Computer video games are well known in the art. Such devices range from small hand held all-in-one units, to larger stand-alone units which interact with stand alone controllers and stand alone video display devices. Stand-alone computer gaming units all require the use of a display device such as a television. These stand-alone units are specifically suited for home use. The stand-alone gaming unit is positioned proximate the television or similar video display device.

Many stand-alone computer gaming units often include the power switch on the back panel, often times located near the power inlet. This positioning of the power switch forces a user or operator to access the back panel from behind the unit in order to turn the power on or off.

Many users install the stand-alone computer gaming units in conjunction with other audio or video devices, such as DVD players, stereos, cable receivers, etc. Thus, the stand-alone computer gaming unit is usually placed within an entertainment center or stacked alongside in series with the additional components. Many of the on/off switches for conventional computer gaming units are located on the back of the unit. When the power switch is located on the back panel of the stand-alone unit, it is very difficult for a user to reach behind the unit to turn the power on or off when the unit is located in a tight space. For example, many entertainment centers and arrangements currently used provide less space for accessing the backside of components contained therein. Thus, when it becomes necessary to turn the power on or off for a component with the power switch on the back panel, such as a stand-alone computer gaming unit, it is necessary to remove the entire stand-alone unit to access the on/off switch.

In addition, the prior art units do not incorporate a surge protector within to protect the platform. With the advent of newer systems and electronic equipment, more and more power is drawn through the conventional electric layouts in homes today. This increase is drawn power can result in a power spike or rapid voltage increase. Such spikes in voltage can damage or destroy electrical equipment. In order to protect electrical devices, users employ independent surge protectors. Surge protectors are set up in series and positioned between the voltage source and the electrical equipment to be protected. Surge protectors integrate a fuse so that should the voltage exceed a specified level, a fuse is tripped to break the flow of voltage to the electrical components.

The addition of independent surge protectors requires an additional piece of equipment to be carried with an electrical system. One of the advantages of a stand-alone computer gaming unit is the mobility. A user can move the unit from location to location with relative ease. If the user now needs to carry an additional surge protector, the overall mobility of the unit is decreased. Furthermore, conventional surge protectors are bulky and difficult to hide. Furthermore, numerous electrical devices are plugged into a power track associated with the surge protector.

### SUMMARY OF THE INVENTION

The present invention is directed to a power module that is affixed to a stand-alone computer gaming unit and permits an operator or user to turn the power either on or off from the front of the stand-alone gaming unit or other relocated position. A surge protector is formed integral with the main body to prevent damage or harm to the stand-alone computer gaming unit in the event of a power spike or surge.

The power module is constructed so that a main power cord attaches to the stand-alone computer gaming unit where the stand-alone computer gaming unit power inlet source is located and connects the unit to a power source, such as a outlet. A secondary power cord is run off of the main power cord to an independent on/off switch to facilitate relocation of the on/off switch.

In one embodiment, the relocated on/off switch is located within a grill to be attached to the stand-alone computer gaming unit. Furthermore, a frequency response module is also connected to the secondary power cord. The frequency response module includes lights with associated circuitry that act in response to volume. The lights are a series of LED lights.

A surge protector is formed in the main body with the main power cord of the power module. A control pad feeds off the main body and has an on/off switch to regulate power to the stand-alone computer gaming unit.

In another embodiment, a remote control pad is used to send a signal to the main body in order to control the power. A radio frequency transmitter and is included in a remote control pad to send a signal to a radio frequency receiver located in the main body of the power module. A switch on the remote control pad activates the RF transmitter when pressed by a user. The RF transmitter then activates the RF receiver to either turn the power on or off to the stand-alone computer gaming device.

### BRIEF DESCRIPTION OF THE DRAWINGS

FIG. 1 is a plan view of a power module in conjunction with a stand-alone computer gaming device according to one embodiment of the present invention.

FIG. 2 is an exploded rear view of a power module with associated stand-alone computer gaming device as shown in FIG. 1.

FIG. 3 is an exploded top view of a power module with associated stand-alone computer gaming device as shown in FIG. 1.

FIG. 4 is a front profile view of the power module with a stand-alone computer gaming unit.

FIG. 5 is an alternate embodiment of the power module that is capable of connecting to a stand-alone computer gaming unit.

FIGS. 6a and 6b are views of an alternate embodiment of the present invention showing a power module capable of providing a surge protection module within the power module.

FIG. 7a is a view of an alternate embodiment of the present invention showing a power module with a surge protection module and an on/off switch running on a leader.

FIG. 7b is a view of yet another alternate embodiment of the present invention showing a power module with a surge protection module and a remote sending unit to power on or off a stand-alone computer gaming unit.

### DETAILED DESCRIPTION OF THE PREFERRED EMBODIMENTS

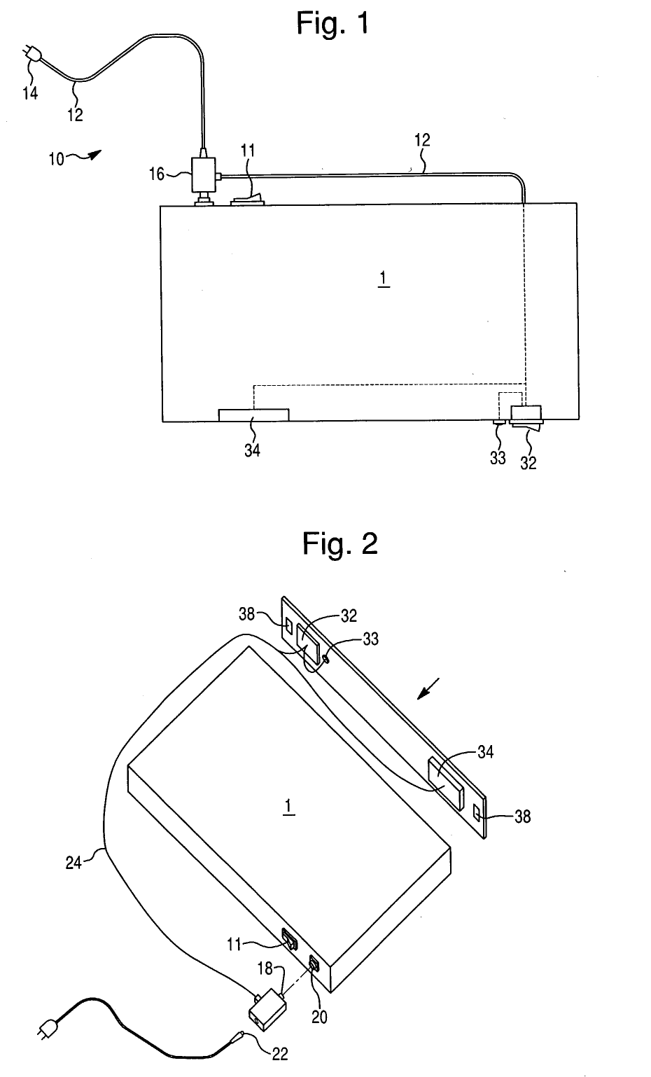

Typically, many stand-alone computer gaming units 1 have an on/off switch 11 located on the rear panel or backside of the unit as seen in FIG. 1. Thus, a power module 10 is provided.

The power module 10 connects to the existing main power cord 12. The power cord 12 also connects into an outlet, such as a conventional house outlet, and into the power inlet on a stand-alone gaming unit 1. A secondary cord or wiring harness 24 feeds off of the main cord 12 (Sony's cord). An independent on/off or power switch 32 that allows a user to selectively position the independent on/off switch to a location that facilitates easier access than the stand-alone computer gaming unit's integrated power switch 11 by a user.

FIG. 1 depicts a power module 10 as it is connected to the stand-alone computer gaming unit 1. The power module 10 has a power cord 12 included with the original system. At one end of the power cord 12 is a plug 14 that has a pair of prongs designed to fit within an electrical outlet (not shown). The plug 14 is designed to allow the flow of electricity through the power cord 12 to and from the stand-alone computer gaming unit 1.

Additionally, the power cord 12 has a male stub 22 that engages with an opening within the main body 16 of the power module 10 as seen in FIG. 2. The main body 16 also has a stem 18 designed to fit into a receptacle 20 of the stand-alone computer gaming unit 1. This male stub 22 allows the power cord 12 to be disconnected or connected to the main body 16 as needed by an operator or user while maintaining connection between the main body 16 and the stand-alone computer gaming device 1.

The stem 18 is specifically designed to fit a particular stand-alone computer gaming device. For example, Sony's™ Play Station 2™ requires a particular shape of the stem 18 in order to fit properly in the receptacle 20 of the PSII™. Usually, this particular stem shape is not compatible with other gaming devices, such as the Gamecube™. Thus, the power module 10 can be designed with several stem shapes to fit various stand-alone computer gaming devices.

A plurality of stems having differing shapes to mate with a particular device could then be interchangeable with the main body 16 so that the same power module can be used on a myriad of gaming units depending on the stem utilized.

The main body 16 also contains a surge protector to thwart the destruction or damage of the stand-alone computer gaming unit 1 in the event of a power surge. This provides an owner and operator with additional safety so that the stand-alone computer gaming unit 1 can be remain connected to the main power source in conditions conducive to power spikes. Some examples include peak power usage on a particular power grid, electrical storms, use in conjunction with heavy electrical equipment, etc.

The surge protector is integrally formed with the main body 16 and arranged between the power source connected to the plug 14 and the power inlet 20 of the computer gaming unit 1. In the event a power surge is experienced, the surge protector breaks the connection of the power supply before the power surge reaches the computer gaming unit 1.

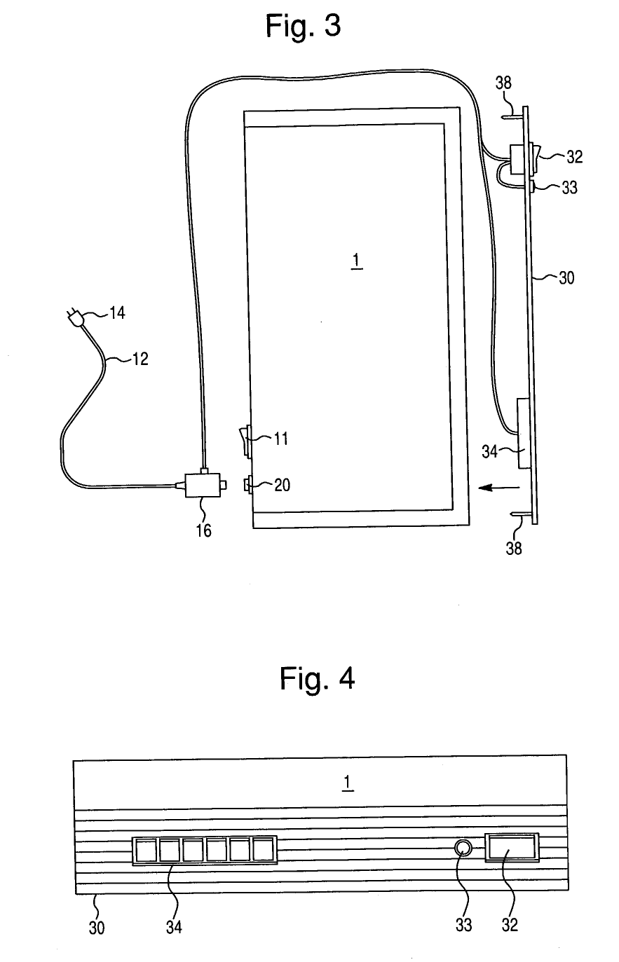

The union of the power module 10 to the to the front of the stand-alone computer gaming unit 1 will now be described with reference to FIGS. 3 and 4. The power module 10 includes a grill 30 that houses an on/off switch 32 and a frequency response module 34. The grill 30 is designed such that it fits flush over the front portion of the stand-alone computer gaming unit 1. Any method know to those skilled in the art can be employed to maintain a secure fit between the grill 30 and the stand-alone computer gaming unit 1. As seen in FIG. 3, tabs 38 are located on the sides of the grill 30. The tabs 38 have an inward facing surface 39 has a surface so that when the grill is pressed against the front of the stand-alone computer gaming device, the coefficient of friction between the two elements is enough to maintain a tight fit. The tabs 39 may also be inclined slightly to create an acute angle between the back surface of the grill 30 and the inward facing surface 30 of the tabs 38.

Located within the grill 30 is an independent on/off switch 32. The independent on/off switch 32 is used to control the power to the stand-alone computer gaming unit 1 from the main body 16 of the power module. A wiring harness 24 is used to connect the switch 32 to the main body 16. The wiring harness 24 is connected to the main body 16 of the power module 10.

Once the power module 10 has been attached to the stand-alone computer gaming unit 1, the user or operator turns the integrated main power switch 11 of the stand-alone computer gaming unit 1 to the “on” position and leaves it in the “on” position. The power module 10 then regulates power flow to the stand-alone computer gaming unit 1 from a power source through the independent on/off switch 32.

As seen in FIG. 4, a LED power indicator 33 is located adjacent the independent on/off switch 32. Once a user or operator places the independent on/off switch 32 in the “on” position, the LED power indicator 33 receives a voltage to light the indicator 33. Likewise, when the user or operator turns the switch 32 to an “off” position, the voltage supplied to the LED power indicator 33 is terminated and the LED power indicator 33 is no longer lit up. The LED power indicator 33 is connected to the wiring harness such that the voltage flow when the on/off switch 32 is in the “on” position will also pass through the LED power indicator 33 to provide a light.

The LED power indicator can be any color as preferred by the user. In the present invention, a blue LED light is used. The blue LED is distinguishable from another LED indicator discussed herein.

Preferably, the frequency response module 34 is series of LED lights with associated circuitry that act in response to a particular condition of the stand-alone computer gaming unit 1. For example, the associated circuitry measures specific volume and/or beats. The associated circuitry facilitates display of a signal in the form of lit LED lights fluctuations. The associated circuitry and the LED lights for the frequency response module 34 are contained within the body of the grill 30. The frequency response module 34 is positioned to be readily visible to the user or operator when viewing the stand-alone computer gaming unit 1 in conjunction with the power module from the front.

The power for the frequency response module 34 is supplied via a small voltage from the power cord 12 or the wiring harness 24 in response to activation of the independent on/off switch 32 to the “on” position. Once the on/off switch 12 is turned on, the LED lights of the frequency response module 34 light in response to the volume generated though the stand-alone computer gaming device 1.

The specific makeup of the frequency response module 34 can vary depending on preference. For example, the audio output indicator can be comprised of several individual bars visible through the grill, or may be a single bar that is scaled in response to the voltage received from within the system. This technology is well known to those skilled in the art as evidenced by the numerous electronics available to the public.

Similarly, the LED lights utilized within the frequency response module 34 can be of various colors. Either the bar and the LED lights can all be the same color; or the bar and individual LED lights may vary to indicate reaching certain thresholds of audio level.

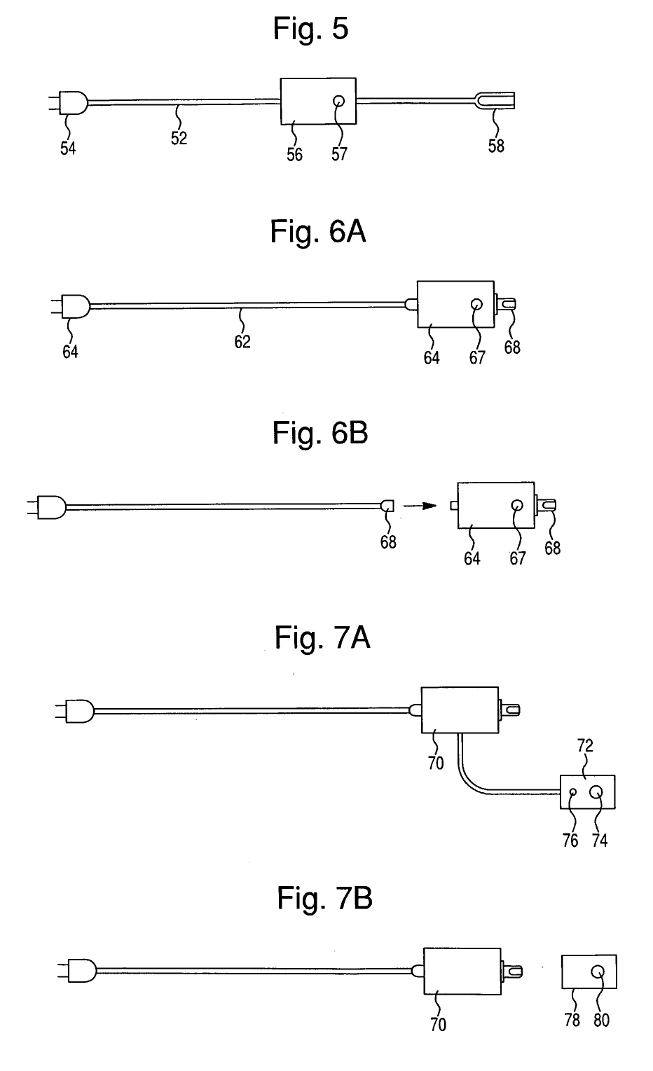

Referring now to FIG. 5, an alternate embodiment of the present invention includes the power cord 52 with an integral surge protector. Conventional computer gaming units do not include a single power cord with an integrated surge protector. As previously mentioned, should a user need to transport the computer gaming unit and additional surge protector is required to also be carried to ensure complete protection. The present invention eliminates the need for an additional element by incorporating the surge protector within the power cord.

Here again, the power cord 52 has a plug 54 and a main body 56. The main body 56 also houses a surge protector within and has a line leading to a stem 58 for insertion into a stand-alone computer gaming unit (not shown). The main body 56 also has a reset button 57. The reset button 57 is used to reset the circuit breaker should a surge or spike in power or electricity trip the breaker within the surge protector.

FIGS. 6a and 6b show an additional embodiment of the present invention, wherein the power module 60 includes a power cord 62 and a main body 64. The power cord 62 has a plug 61 at one end designed to plug into a house outlet and a stub 66 designed to engage the main body 64. Again the main body 64 has a surge protector integrated therein with a reset button as in the previous embodiment. A stem 68 is provided to engage a power receptacle (not shown) of a stand-alone computer gaming unit. The stub 66 may also be the same shape and design as the stem 68, so that the power cord 52 may be used to power the stand-alone computer gaming unit without the main body 64.

FIGS. 7a and 7b show an alternate embodiment for permitting control of the flow of electricity to the stand-alone computer gaming unit. In FIG. 7a, a line runs off the main body 70 to a control pad 72. The control pad 72 has an independent on/off switch 74 that controls the flow of power through the main body 70. Also on the control pad 72 is a reset button 76. The reset button 76 is used to reset the surge protector in the event the electrical circuit is broken due a spike or surge of power. In the alternative, an LED light (not shown) may also be located on the control pad 72 to indicate the status of the power, when the power in “on” the LED light is lit. Is some embodiments, the reset button 76 is strictly a reset button, while an alternative embodiment fits the reset button with a built-in LED for power indication. Further, while not shown in the drawings, the main body 70 can be designed such that a LED power indicator is positioned so that when power is on, the LED light on the main body 70 lights.

In FIG. 7b, a remote control pad 78 is used to interface with the main body 70. The remote control pad 78 has a radio frequency transmitter located within that transmits a specific frequency in response to activation of a button or switch 80. The main body 70 contains a radio frequency receiver designed to receive the specific frequency transmitted by the radio frequency transmitter in the remote control pad 78. When a user presses the button or switch 80 in the remote control pad 78, the power supply to the computer gaming unit in controlled.

While the foregoing invention has been shown and described with reference to a preferred embodiment, it will be understood by those possessing skill in the art that various changes and modifications may be made without departing from the spirit and scope of the invention.

What is claimed is:

1. A power module for a computer gaming unit comprising:
a power cord having a plug disposed on one end thereof for engaging an outlet and a stem formed for engaging a receptacle of said computer gaming unit; and
an independent on/off switch to selectively control power to a computer gaming device and facilitate relocation of said independent on/off switch.

2. The power module according to claim 1, further comprising a main body having an integral surge protector formed therein, wherein said main body is disposed on said power cord between said outlet and said receptacle.

3. The power module according to claim 1, further comprising a grill affixed to a face of said computer gaming device, said independent on/off switch being disposed on a grill.

3. The power module according to claim 2, wherein said grill has a LED power indicator light located adjacent said switch.

4. The power module according to claim 2, wherein said grill further comprises frequency response module for acting in response to a level of volume.

5. The power module according to claim 4, wherein said frequency response module is formed from a plurality of LED lights.

6. The power module according to claim 1, wherein said power cord is operably detachable with a main body with an integral surge protector so that a user may selectively disconnect said power cord from said main body.

7. The power module according to claim 6, wherein said main body has a reset button integrally formed to reset said surge protector.

8. The power module according to claim 1, wherein a control pad is connected to said main body through a second power cord, and said control pad has an on/off switch for turning the power on and off.

9. The power module according to claim 1, wherein a radio frequency transmitter contained in a remote control pad interfaces with a radio frequency receiver within a main body attached to said power cord to allow an on/off button located on said remote control pad to regulate power flow to said computer gaming unit.

10. A power module for a computer gaming unit comprising:
a power cord having a plug disposed on one end thereof for engaging an outlet and a stem formed for engaging a receptacle of said computer gaming unit;
a main body located on said power cord between said plug and said stem, wherein said main body has a surge protector therein; and
an independent on/off switch to selectively control power to a computer gaming device and facilitate relocation of said independent on/off switch.
